(19) United States
(12) Patent Application Publication
(10) Pub. No.: US 2019/0218978 A1
(43) Pub. Date: Jul. 18, 2019

(54) ACCESSORY GEARBOX ASSEMBLY AND A GAS TURBINE ENGINE COMPRISING AN ACCESSORY GEARBOX ASSEMBLY

(71) Applicant: ROLLS-ROYCE plc, London (GB)

(72) Inventors: David A. EDWARDS, Derby (GB); Stewart T. THORNTON, Derby (GB)

(73) Assignee: ROLLS-ROYCE plc, London (GB)

(21) Appl. No.: 16/233,526

(22) Filed: Dec. 27, 2018

(30) Foreign Application Priority Data
Jan. 16, 2018 (GB) 1800673.4

(51) Int. Cl. F02C 7/32; F02C 7/268; F16H 57/038

(52) U.S. Cl. CPC F02C 7/32; F02C 7/268; F16H 57/038; F16H 2057/02039; F05D 2260/4031; F05D 2260/85; F05D 2220/76; F05D 2220/50

(57) ABSTRACT

A gas turbine engine accessory gearbox assembly comprising an accessory gearbox and a plurality of accessories arranged to be driven by the accessory gearbox. The accessory gearbox comprises a gear train and an accessory gearbox casing enclosing the gears of the gear train. Each accessory is driven by a shaft and the shaft of each accessory has a spur gear. The gear train comprises the spur gears of the accessories. The shaft of at least one of the accessories has a bevel gear and the bevel gear is arranged to mesh with a further bevel gear and the further bevel gear is arranged to drive the accessory gearbox assembly. The accessories may be arranged in V-shape on the core engine casing within an aerodynamic core nacelle.

The present disclosure relates to an accessory gearbox assembly and in particular to an accessory gearbox assembly for a gas turbine engine.

An accessory gearbox assembly generally comprises an accessory gearbox and a plurality of accessories. One known accessory gearbox comprises a gear train of spur gears, each of which is arranged to drive a respective one of the accessories. The accessories are either mounted on the upstream end of the accessory gearbox, the downstream end of the accessory gearbox or the upstream end and the downstream end of the accessory gearbox. The accessories include a low pressure fuel pump, a high pressure fuel pump, a fuel flow governor, an oil pump, a hydraulic pump, a starter motor, an electrical generator, a tachometer, a permanent magnet alternator, e.g. a permanent electrical generator. Thus, the accessory gearbox carries and drives the accessories. The accessory gearbox is driven by a drive shaft which extends generally radially with respect to the axis of the gas turbine engine from an internal gearbox driven by one or more shafts of the gas turbine engine.

The accessory gearbox is mounted on the fan casing of a turbofan gas turbine engine or is mounted on the core engine casing of a turbofan gas turbine engine or other type of gas turbine engine. The accessory gearbox is generally arranged such that it forms an arcuate shape which extends circumferentially around the fan casing, or the core engine casing, and the axes of the accessories are arranged generally parallel to the axis of the gas turbine engine and as mentioned above the accessories are mounted on the axially upstream end of the accessory gearbox, the axially downstream end of the accessory gearbox or the axially upstream end and the axially downstream end of the accessory gearbox.

However, in the case of this type of accessory gearbox mounted on the core engine casing of a gas turbine engine, e.g. a turbofan gas turbine engine, the accessory gearbox prevents other components extending axially along the core engine casing.

In another accessory gearbox assembly the axes of the accessories are arranged perpendicular to a plane containing the axis of the gas turbine engine, e.g. the turbofan gas turbine engine, and the accessory gearbox is generally arranged such that it extends axially along the fan casing or the core engine casing. The accessories are either mounted on one of the circumferentially, tangentially, spaced ends of the accessory gearbox or both of the circumferentially, tangentially, spaced ends of the accessory gearbox.

However, with this type of accessory gearbox mounted on the core engine casing of a turbofan gas turbine engine at least some of the larger accessories may either protrude through an aerodynamic nacelle arranged around the core engine casing or the shape of aerodynamic nacelle may have to be adjusted so that the accessories are located within the aerodynamic nacelle. These alternatives affect the flow of air through a fan duct, or a bypass duct, arranged between the aerodynamic nacelle around the core engine and an outer aerodynamic nacelle.

In a further accessory gearbox assembly the axes of the accessories are arranged in a V-shape and the accessory gearbox is generally arranged such that it extends axially along the fan casing or the core engine casing. With this type of accessory gearbox mounted on the core engine casing of a turbofan gas turbine engine it is possible to arrange the accessories such that they do not protrude through the aerodynamic nacelle arranged around the core engine casing. This accessory gearbox assembly has a shaft driven by a bevel gear and the shaft is arranged parallel to the axis of the gas turbine engine. The shaft has a plurality of axially spaced bevel gears each of which is arranged to drive a bevel gear of an accessory. In this arrangement it is necessary to accurately align the bevel gears on the shaft and the bevel gears of the accessories using shims and this is difficult and time consuming.

Accordingly the present disclosure seeks to provide a novel accessory gearbox assembly which reduces or over comes the above mentioned problems.

According to a first aspect of the present disclosure there is provided an accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a shaft,
a first plurality of accessories are secured to a first side of the accessory gearbox casing, the shafts of the first plurality of accessories are parallel, the shaft of each accessory of the first plurality of accessories has a spur gear, the shaft of a first accessory of the first plurality of accessories has a bevel gear, a second plurality of accessories are secured to a second opposite side of the accessory gearbox casing, the shafts of the second plurality of accessories are parallel, the shaft of each accessory of the second plurality of accessories has a spur gear, the shaft of a second accessory of the second plurality of accessories has a bevel gear,
the gear train comprises the spur gears of the accessories,
the bevel gear of the first accessory is arranged to mesh with a further bevel gear and the bevel gear of the second accessory is arranged to mesh with the further bevel gear, the shafts of the accessories are arranged in a V-shape, and the further bevel gear is arranged to drive the accessory gearbox assembly.

The spur gears of a least some of the accessories may be arranged to mesh to transmit drive through the gear train. The spur gear on the shaft of each accessory may be arranged to mesh with one or more spur gears on the corresponding shaft of other accessories.

The gear train may comprise at least one idler gear, the spur gears of a least some of the accessories are arranged to mesh with idler gears to transmit drive through the gear train. The spur gear on the shaft of each accessory may be arranged to mesh with one or more idler gears which mesh with the spur gears on the corresponding shaft of other accessories.

The shaft of each accessory may be supported on an associated accessory casing by two bearings.

The at least one accessory may be the highest power and/or the highest torque accessory. The at least one accessory may be a starter, an electrical motor or an electrical generator. The electrical motor may be an electrical starter motor.

The first accessory may be a starter, an electrical motor or an electrical generator. The electrical motor may be an electrical starter motor. The second accessory may be an electrical generator.

The shafts of the first plurality of accessories may be arranged in a first plane and the shafts of the second plurality of accessories are arranged in a second plane. The first plane and the second plane may be arranged at an angle of less than 180°. The first plane and the second plane may be arranged at an angle of less than 160° and more than 120°. The first plane and the second plane may be arranged at an angle of 140°.

The further bevel gear may be driven by an additional bevel gear. The further bevel gear may be arranged to be driven by a starter or starter motor.

According to a second aspect of the present disclosure there is provided a gas turbine engine comprising an accessory gearbox assembly, the accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a shaft,
a first plurality of accessories are secured to a first side of the accessory gearbox casing, the shafts of the first plurality of accessories are parallel, the shaft of each accessory of the first plurality of accessories has a spur gear, the shaft of a first accessory of the first plurality of accessories has a bevel gear,
a second plurality of accessories are secured to a second opposite side of the accessory gearbox casing, the shafts of the second plurality of accessories are parallel, the shaft of each accessory of the second plurality of accessories has a spur gear, the shaft of a second accessory of the second plurality of accessories has a bevel gear,
the gear train comprises the spur gears of the accessories,
the bevel gear of the first accessory is arranged to mesh with a further bevel gear and the bevel gear of the second accessory is arranged to mesh with the further bevel gear, the shafts of the accessories are arranged in a V-shape, and the further bevel gear is arranged to drive the accessory gearbox assembly.

The spur gears of a least some of the accessories may be arranged to mesh to transmit drive through the gear train. The spur gear on the shaft of each accessory may be arranged to mesh with one or more spur gears on the corresponding shaft of other accessories.

The gear train may comprise at least one idler gear, the spur gears of a least some of the accessories are arranged to mesh with idler gears to transmit drive through the gear train. The spur gear on the shaft of each accessory may be arranged to mesh with one or more idler gears which mesh with the spur gears on the corresponding shaft of other accessories.

The shaft of each accessory may be supported on an associated accessory casing by two bearings.

The at least one accessory may be the highest power and/or the highest torque accessory. The at least one accessory may be a starter, an electrical motor or an electrical generator. The electrical motor may be an electrical starter motor.

The first accessory may be a starter, an electrical motor or an electrical generator. The electrical motor may be an electrical starter motor.

The second accessory may be an electrical generator.

The shafts of the first plurality of accessories may be arranged in a first plane and the shafts of the second plurality of accessories are arranged in a second plane. The first plane and the second plane may be arranged at an angle of less than 180°. The first plane and the second plane may be arranged at an angle of less than 160° and more than 120°. The first plane and the second plane may be arranged at an angle of 140°.

The further bevel gear may be driven by an additional bevel gear. The further bevel gear may be arranged to be driven by a starter or a starter motor.

The further bevel gear may be arranged on the radially outer end of a radial drive shaft.

The additional bevel gear may be arranged on the radially outer end of a radial drive shaft.

The accessory gearbox casing may be mounted on a core engine casing of the gas turbine engine. A core nacelle may be arranged around the core engine casing, the accessory gearbox and the plurality of accessories are arranged radially between the core engine casing and the core nacelle.

The gas turbine engine may have an axis and the accessory gearbox casing extends axially with respect to the gas turbine engine. The core engine casing may be arranged in the angle between the first plane and the second plane. The first and second planes may intersect a vertical plane containing the axis of the gas turbine engine. The first plane may be horizontal.

A heat shield may be arranged radially between the accessory gearbox and the plurality of accessories and the core casing.

The gas turbine engine may be a turbofan gas turbine engine or a geared turbofan gas turbine engine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments will now be described by way of example only, with reference to the Figures, in which:

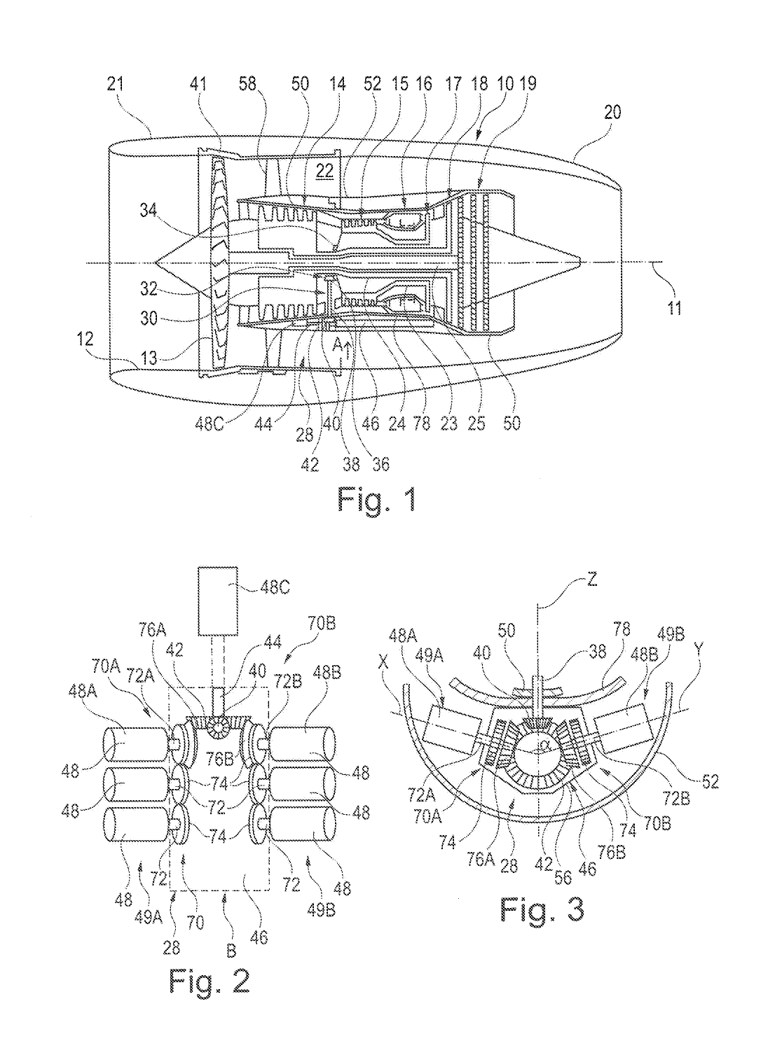

FIG. 1 is a sectional side view of a gas turbine engine having an accessory gearbox assembly according to the present disclosure.

FIG. 2 is an enlarged view of the accessory gearbox assembly in the direction of arrow A in FIG. 1.

FIG. 3 is a view of the accessory gearbox assembly in the direction of arrow B in FIG. 2.

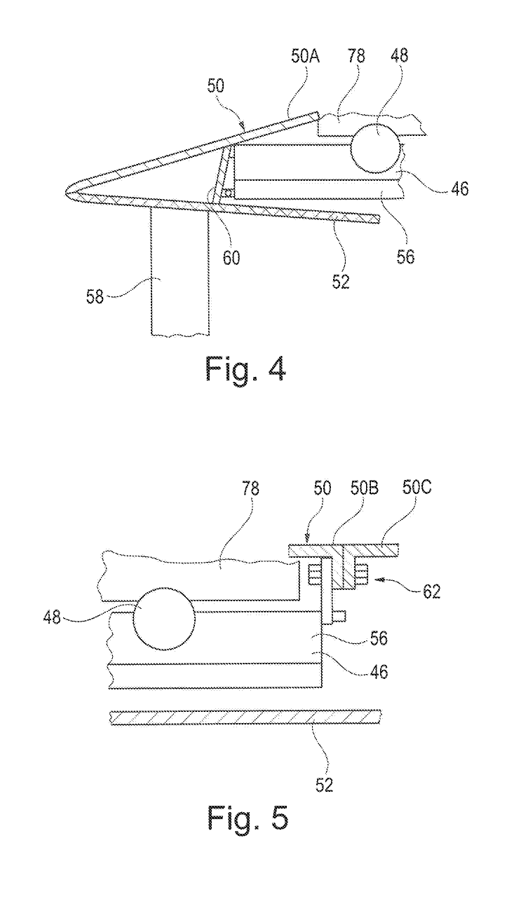

FIG. 4 is an enlarged view of an upstream end of the accessory gearbox assembly and a mounting arrangement to the gas turbine engine shown in FIG. 1.

FIG. 5 is an enlarged view of a downstream end of the accessory gearbox assembly and a mounting arrangement to the gas turbine engine shown in FIG. 1.

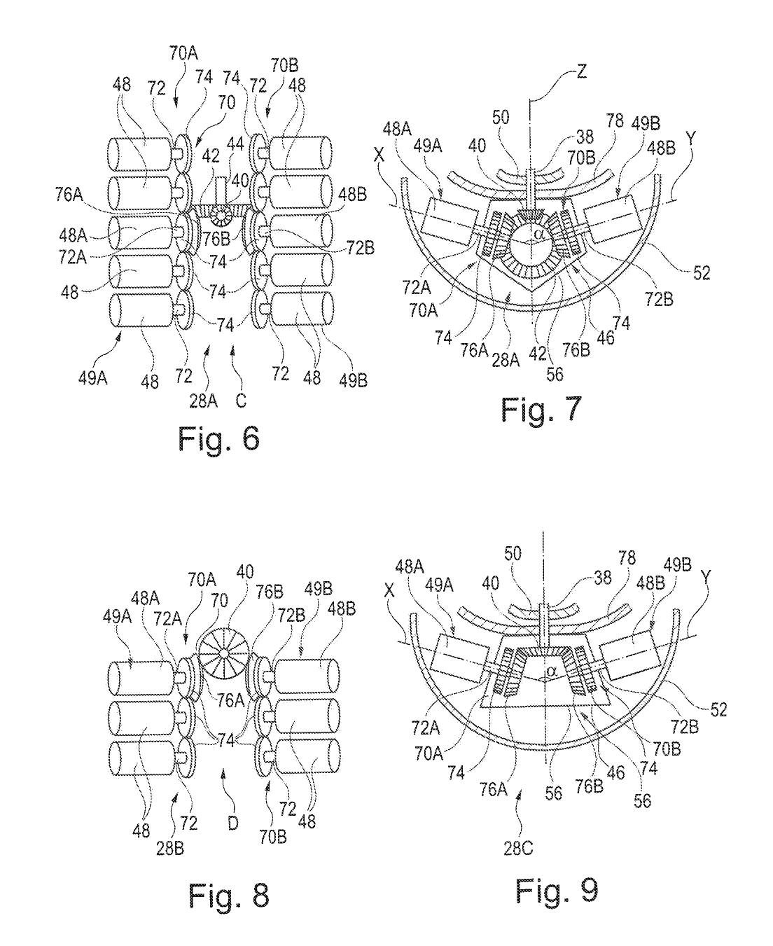

FIG. 6 is an enlarged view of an alternative accessory gearbox assembly in the direction of arrow A in FIG. 1.

FIG. 7 is a view of the alternative accessory gearbox assembly in the direction of arrow C in FIG. 6.

FIG. 8 is an enlarged view of an additional accessory gearbox assembly in the direction of arrow A in FIG. 1.

FIG. 9 is a view of the additional accessory gearbox assembly in the direction of arrow D in FIG. 8.

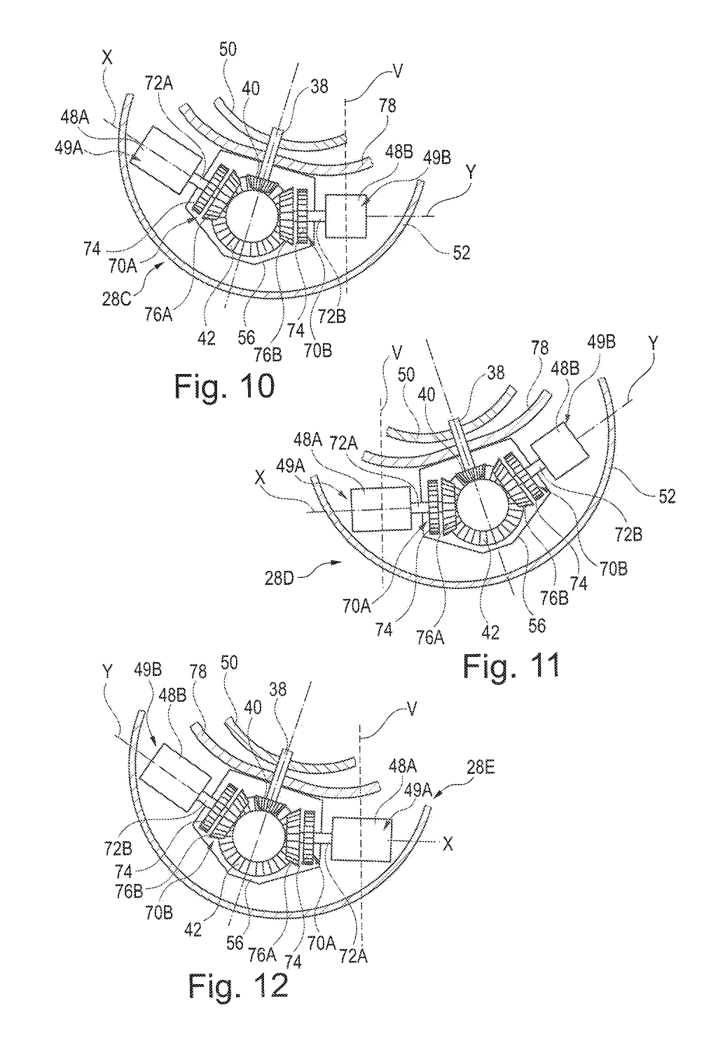

FIG. 10 is an alternative view of the accessory gearbox assembly in the direction of arrow B in FIG. 2.

FIG. 11 is an alternative view of the accessory gearbox assembly in the direction of arrow B in FIG. 2.

FIG. 12 is an alternative view of the accessory gearbox assembly in the direction of arrow B in FIG. 2.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shafts 23, 24 and 25 respectively.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

A core engine casing 50 is secured to a fan casing 41 which surrounds the fan 13 by a plurality of radially extending circumferentially spaced fan outlet guide vanes 58. The fan casing 41 is integrated into the structure of the nacelle 21. A core nacelle 52 defines a radially inner surface, or radially inner boundary, of the bypass duct 22 and the nacelle 21 defines the radially outer surface, or radially outer boundary, of the bypass duct 22. The nacelle 21 and the core nacelle 52 are aerodynamically shaped to optimise the flow of air through the bypass duct 22 and the nacelle 21 is aerodynamically shaped to optimise the flow of air over the radially outer surface of the nacelle 21.

The gas turbine engine 10 further comprises an accessory gearbox assembly 28. The accessory gearbox assembly 28 is drivingly connected to the shaft 23 connecting the high pressure compressor 15 and the high pressure turbine 17 via drive means 30. However, in other embodiments the accessory gearbox assembly 28 may be driven by the shaft 24 connecting the intermediate pressure compressor 14 and the intermediate pressure turbine 18 or by the shaft 25 connecting the fan 13 and the low pressure turbine 19. In this arrangement the drive means 30 comprises an internal gearbox 32 provided at the upstream end of the shaft 23. The internal gearbox 32 comprises a bevel gear 34 at the upstream end of the shaft 23 and a bevel gear 36 arranged on the radially inner end of a radial drive shaft 38. The bevel gear 36 on the radial drive shaft 38 is arranged to mesh with the bevel gear 34 on the shaft 23. The radial drive shaft 38 extends through a strut extending across the flow path from the intermediate pressure compressor 14 to the high pressure compressor 15. A bevel gear 40 is provided on the radially outer end of the radial drive shaft 38 and the bevel gear 40 is arranged to mesh with a further bevel gear 42 on a shaft 44. The further bevel gear 42 is arranged to provide drive for the accessory gearbox assembly 28.

The accessory gearbox assembly 28 comprises an accessory gearbox 46 and a plurality of accessories 48 arranged to be driven by the accessory gearbox 46. The accessory gearbox 46 is mounted on the core engine casing 50 and is arranged radially within the core nacelle 52 which is arranged around the core engine casing 50 and thus the accessory gearbox 46 is arranged radially between the core engine casing 50 and the core nacelle 52. The accessories 48 are also arranged radially between the core engine casing 50 and the core nacelle 52. An accessory gearbox casing 56 of the accessory gearbox 46 is mounted on the core engine casing 50.

The accessory gearbox casing 56 is mounted at an upstream end, as shown more clearly in FIG. 4 to a structural panel 60 connecting the radially inner ends of the fan outlet guide vanes 58 to the core engine casing 50 in a region of the core engine casing 50A around the intermediate pressure compressor 14. The accessory gearbox casing 56 is mounted at a downstream end, as shown more clearly in FIG. 5, to the core engine casing 50 and in particular to a flanged joint 62 between the core engine casing 50B around the high pressure turbine 17 and the core engine casing 50C around the intermediate pressure turbine 18 in this example with a high pressure turbine 17, an intermediate pressure turbine 18 and a low pressure turbine 19. The accessory gearbox casing 56 is mounted at a downstream end to a flanged joint between the casing of the high pressure turbine and the casing of the low pressure turbine in an example with a high pressure turbine and a low pressure turbine.

A shown in FIGS. 1, 4 and 5, the accessory gearbox assembly 28 is arranged at a vertically lower region, a bottom region, of the gas turbine engine 10 in order to enable easy access to the accessories 48 for maintenance purposes.

As mentioned briefly above, the accessory gearbox assembly 28 comprises an accessory gearbox 46 and a plurality of accessories 48 arranged to be driven by the accessory gearbox 46. The accessory gearbox assembly 28 will be described in more detail with reference to FIGS. 2 and 3 which show the accessory gearbox assembly 28 more clearly. The accessory gearbox 46 comprises a gear train 70 and an accessory gearbox casing 56 enclosing the gears of the gear train 70. Each accessory 48 is driven by a shaft 72, the shaft 72 of each accessory 48 has a spur gear 74 and the gear train 70 comprises the spur gears 74 of the accessories 48. The shaft 72A, 72B of at least one of the accessories 48A, 48B has a bevel gear 76A, 76B. The bevel gear 76A, 76B is arranged to mesh with the further bevel gear and the further bevel gear 42 is arranged to drive the accessory gearbox assembly 28. The accessories 48 include a low pressure fuel pump, a high pressure fuel pump, a fuel flow governor, an oil pump, a hydraulic pump, a starter, a starter motor, an electrical generator, a tachometer, a permanent magnet alternator, e.g. a permanent electrical generator.

The spur gears 74 of the accessories 48 are arranged to mesh to transmit drive through the gear train 70. The spur gear 74 on the shaft 72 of each accessory 48 is arranged to mesh with one or more spur gears 74 on the corresponding shaft 72 of other accessories 48. The shaft 72 of each accessory 48 is supported on an associated accessory casing by two bearings (not shown).

It is to be noted that in this arrangement there is a first plurality of accessories 49A secured to a first side of the accessory gearbox casing 56 and the shafts 72 of the first plurality of accessories 49A are parallel. The at least one accessory 48A is the highest power and/or the highest torque accessory. The at least one accessory 48A is a starter, an electrical motor or an electrical generator. The electrical motor may be an electrical starter motor. The starter may be a pneumatic starter, or a hydraulic starter. The starter or electrical starter motor is arranged to start the gas turbine engine 10.

It is to be noted that in this arrangement there is a second plurality of accessories 49B secured to a second opposite side of the accessory gearbox casing 56 and the drive shafts 72 of the second plurality of accessories 49B are parallel. The shaft 72A of a first accessory 48A of the first plurality of accessories 49A has a bevel gear 76A and the shaft 72B of a second accessory 48B of the second plurality of accessories 49B has a bevel gear 76B. The bevel gear 76A of the first accessory 48A is arranged to mesh with the further bevel gear 42 and the bevel gear 76B of the second accessory 48B is arranged to mesh with the further bevel gear 42. The accessories 48A and 48B are the highest power and/or the highest torque accessories. As mentioned above the first accessory 48A may be a starter, an electrical motor or an electrical generator. The second accessory 48B may be an electrical generator. The accessories 48 are generally arranged in the accessory gearbox assembly 28 in order of decreasing power requirements and/or decreasing torque requirements. The accessories 48A, 48B, requiring the greatest power and/or the greatest torque are arranged to be driven directly by the bevel gears 76 and the shafts 72A or 72B, e.g. the accessories 48A and 48B requiring the greatest power and/or the greatest torque are at arranged a location in the gear train 70 nearest to the further bevel gear 42. The accessories 48 requiring the least power and/or the least torque are arranged to be driven by the spur gears 74 and shafts 72 at locations in the gear train 70 remotest from the shafts 72A, 72B, e.g. the accessories 48 requiring the least power and/or the least torque are arranged at a location the gear train 70 furthest from the further bevel gear 42.

The drive shafts 72, 72A of the first plurality of accessories 49A are arranged in a first plane X and the drive shafts 72, 72B of the second plurality of accessories 49B are arranged in a second plane Y. The first plane X and the second plane Y are arranged at an angle α of less than 180°. The first plane X and the second plane Y may be arranged at an angle α of less than 160° and more than 120°. The first plane X and the second plane Y may for example be arranged at an angle α of 140° or other suitable angles. The first and second planes X and Y respectively are non-coplanar with a horizontal plane. The drive shafts 72 of the accessories 48 are arranged in a V-shape and thus the axes of the accessories 48 are arranged in a V-shape. The accessories 48 are cantilevered off the accessory gearbox casing 56 and the remote ends of the accessories 48 are arranged vertically higher than the ends of the accessories 48 secured to the accessory gearbox casing 56. This allows all the accessories 48 to fit in the curved space between the core engine casing 50 and the core nacelle 52.

The accessory gearbox casing 56 is hexagonal in cross-section and the accessory gearbox casing 56 may have an irregular hexagonal cross-section or a regular hexagonal cross-section. The accessories 48 are secured to two sides separated by one side and three sides of the hexagonal accessory gearbox casing 56. The accessory gearbox casing 56 may also have a pentagonal cross-section or an isosceles trapezium cross-section.

The further bevel gear 42 is arranged to be driven by an additional bevel gear, the bevel gear 40. The further bevel gear 42 may be arranged to be driven by a starter or a starter motor 48C via the shaft 44 to start the gas turbine engine 10. The additional bevel gear, the bevel gear, 40 is arranged on the radially outer end of the radial drive shaft 38.

The accessory gearbox 46 and the accessory gearbox casing 56 extend axially with respect to the axis 11 of the gas turbine engine 10. The core engine casing 50 is arranged in the angle α between the first plane X and the second plane Y. The first and second planes X and Y respectively intersect a vertical plane Z containing the axis 11 of the gas turbine engine 10 and the vertical plane Z bisects the angle α. The first and second planes X and Y respectively are non-coplanar with a horizontal plane. The radial drive shaft 38 is also arranged in the vertical plane Z. The axis of the drive shaft 72A, 72B, 72 of each accessory 48 intersects the vertical plane Z containing the axis 11 of the gas turbine engine 10 and the radial drive shaft 38. The axis of the drive shaft 72A, 72 of each accessory 48 in the first plurality of accessories 49A intersects the vertical plane Z containing the axis 11 of the gas turbine engine 10 and the radial drive shaft 38 from a first side of the vertical plane Z and the axis of the drive shaft 72B, 72 of each accessory 48 in the second plurality of accessories 49B intersects the vertical plane Z containing the axis 11 of the gas turbine engine 10 and the radial drive shaft 38 from a second, opposite, side of the vertical plane Z. Thus, as seen the drive shafts 72A, 72B, 72 of the accessories 48 are arranged in a V-shape and thus the axes of the accessories 48 are arranged in a V-shape.

The accessory gearbox assembly 28 has all the accessories 48 in the first plurality of accessories 49A arranged in the first plane X on a first axial side of the accessory 48A and all of the accessories 48 in the second plurality of accessories 49B arranged in the second plane Y on a first axial side of the accessory 48B with respect to the axis 11 of the gas turbine engine 10. The accessories 48 in the first plurality of accessories 49A are spaced apart axially and the accessories 48 in the second plurality of accessories 49B are spaced apart axially with respect to the axis 11 of the gas turbine engine 10.

The accessory gearbox assembly 28 may not have a starter or a starter motor 48C to start the gas turbine engine 10 and in such circumstances the accessory 48A is a starter or starter motor.

The gear train 70 comprises a first gear train portion 70A and a second gear train portion 70B. The first gear train portion 70A comprises the spur gears 74 on the shafts 72, 72A of the accessories 48, 48A of the first plurality of accessories 49A and the bevel gear 76A on the shaft 72A of the first accessory 48A of the first plurality of accessories 49A. The second gear train portion 70B comprises the spur gears 74 on the shafts 72, 72B of the accessories 48, 48B of the second plurality of accessories 49B and the bevel gear 76B on the shaft 72B of the second accessory 48B of the second plurality of accessories 49B. The bevel gear 76A of the first accessory 48A drives the first gear train portion 70A and hence the accessories 48, 48A of the first plurality of accessories 49A. The bevel gear 76B of the second accessory 48B drives the second gear train portion 70B and hence the accessories 48, 48B of the second plurality of accessories 49B.

In another accessory gearbox assembly 28C, as shown in FIG. 10, the first plurality of accessories 49A may be longer than the second plurality of accessories 49B and the second plurality of accessories 49B are arranged in a second plane Y arranged coplanar with a horizontal plane. In this arrangement the radial drive shaft 38 is not arranged in the vertical plane Z. In a further accessory gearbox assembly 28D, as shown in FIG. 11, the first plurality of accessories 49A may be longer than the second plurality of accessories 48 and the first plurality of accessories 49A are arranged in a first plane X arranged coplanar with a horizontal plane. In this arrangement the radial drive shaft 38 is not arranged in the vertical plane Z. In another accessory gearbox assembly 28E, as shown in FIG. 12, the first plurality of accessories 49A are arranged in a first plane X arranged coplanar with a horizontal plane. In FIGS. 10, 11 and 12 the axis of the drive shaft of each accessory 48 intersects a plane containing the axis 11 of the gas turbine engine 10 and the radial drive shaft 38. The axis of the drive shaft 72A, 72 of each accessory 48 in the first plurality of accessories 49A intersects the plane containing the axis 11 of the gas turbine engine 10 and the radial drive shaft 38 from a first side of the plane containing the axis 11 of the gas turbine engine 10 and the radial drive shaft 38 and the axis of the drive shaft 72B, 72 of each accessory 48 in the second plurality of accessories 49B intersects the plane containing the axis 11 of the gas turbine engine 10 and the radial drive shaft 38 from a second, opposite, side of the plane containing the axis 11 of the gas turbine engine 10 and the radial drive shaft 38. The drive shafts 72 of the accessories 48 are arranged in a V-shape and thus the axes of the accessories 48 are arranged in a V-shape.

A heat shield 78 is arranged radially between the accessory gearbox 46 and the plurality of accessories 48 and the core engine casing 50. The heat shield 78 extends over an arc around the circumference of the core engine casing 50 to reduce or prevent heat radiation, heat conduction or heat convection from the components of the gas turbine engine 10 to the accessory gearbox 46 and the accessories 48. The arc of the heat shield 78 extends over an angle sufficient to shield the accessory gearbox 46 and the full length of all of the accessories 48. The heat shield 78 may be an insulating blanket. The insulating blanket may comprise a fibrous insulating material located between two metal skins, e.g. steel skins. The heat shield 78 is secured to the core engine casing 50.

Another accessory gearbox assembly 28A will be described with reference to FIGS. 6 and 7 and the accessory gearbox in FIGS. 6 and 7 is similar to the accessory gearbox assembly 28 shown in FIGS. 2 and 3 and like part are denoted by like numerals. The accessory gearbox assembly 28A differs in that some of the accessories 48 in the first plurality of accessories 49A are arranged in the first plane X on a first axial side of the accessory 48A with respect to the axis 11 of the gas turbine engine 10 and some of the accessories 48 in the first plurality of accessories 49A are arranged in the first plane X on a second, opposite, axial side of the accessory 48A with respect to the axis 11 of the gas turbine engine 10 and some of the accessories 48 in the second plurality of accessories 49B are arranged in the second plane Y on a first axial side of the accessory 48B with respect to the axis 11 of the gas turbine engine 10 and some of the accessories 48 in the second plurality of accessories 49B are arranged in the second plane Y on a second, opposite, axial side of the accessory 48B with respect to the axis 11 of the gas turbine engine 10. The accessory gearbox casing 56 is pentagonal in cross-section and the accessory gearbox casing 56 may have an irregular pentagonal cross-section or a regular pentagonal cross-section. The accessories 48 are secured to two sides on opposite ends of the base of the pentagonal accessory gearbox casing 56. The accessory gearbox assembly 28A may have a starter or a starter motor 48C to start the gas turbine engine 10 or the accessory gearbox assembly 28A may not have a starter or a starter motor 48C to start the gas turbine engine 10 and in such circumstances the accessory 48A is a starter or starter motor.

Another accessory gearbox assembly 28B will be described with reference to FIGS. 8 and 9 and the accessory gearbox in FIGS. 8 and 9 is similar to the accessory gearbox assembly 28 shown in FIGS. 2 and 3 and like part are denoted by like numerals. The accessory gearbox assembly 28B differs in that the bevel gear 40 on the radial drive shaft 38 meshes with the bevel gears 76 on the shafts 72A and 72B of the accessories 48A and 48B of the first and second plurality of accessories respectively. This accessory gearbox assembly 28B has dispensed with the further bevel gear 42 reducing complexity. The accessory gearbox casing 56 is has an isosceles trapezium cross-section. The accessories 48 are secured to the non-parallel sides of the accessory gearbox casing 56. The accessory gearbox assembly 28B does not have a starter or a starter motor 48C to start the gas turbine engine 10 and in such circumstances the accessory 48A is a starter or starter motor.

In the accessory gearbox assemblies 28, 28A, 28C, 28D and 28E shown in FIGS. 2 and 3, 6 and 7, 10, 11 and 12 respectively the axes of the shafts 72A and 72B intersect the axis of the further bevel gear 42 and define an angle α between the axes of the shafts 72A and 72B. The angle α is less than 180° and in particular the angle α is less than 160° and more than 120° and for example the angle α is 140°. In the accessory gearbox assembly 28B shown in FIGS. 8 and 9 the axes of the shafts 72A and 72B intersect a line parallel to the axis of the bevel gear 40 and define an angle α between the axes of the shafts 72A and 72B. The angle α is less than 180° and in particular the angle α is less than 160° and more than 120° and for example the angle α is 140°.

In all of the accessory gearbox assemblies of the present disclosure the drive shafts of the accessories are arranged in a V-shape and the drive shafts of the accessories are axially spaced apart with respect to the axis of the gas turbine engine and thus the axes of the accessories are arranged in a V-shape and thus the axes of the accessories are axially spaced apart with respect to the axis of the gas turbine engine.

An advantage of all of the accessory gearbox assemblies of the present disclosure compared to an accessory gearbox assembly which is generally arranged such that the auxiliary gearbox forms an arcuate shape which extends circumferentially around the core engine casing is that it allows other components to extend axially along the core engine casing.

An advantage of all of the accessory gearbox assemblies of the present disclosure compared to an accessory gearbox assembly which is generally arranged such that the auxiliary gearbox extends axially along the core engine casing is that it is possible to arrange the larger accessories so that they do not protrude through an aerodynamic nacelle arranged around the core engine casing and/or the shape of the aerodynamic nacelle does not have to be adjusted so that the accessories are located within the aerodynamic nacelle, e.g. all the accessories fit within the space between the core engine casing and the core nacelle. Thus, the flow of air through the fan duct, or the bypass duct, arranged between the aerodynamic core nacelle around the core engine and an outer aerodynamic nacelle is not compromised by the accessory gearbox assembly.

An advantage of all of the accessory gearbox assemblies of the present disclosure compared to an accessory gearbox assembly which arranges the axes of the accessories such that they are arranged in a V-shape and the accessory gearbox is generally arranged such that it extends axially along the fan casing or the core engine casing is that there is no need for a shaft driven by a bevel gear which is arranged parallel to the axis of the gas turbine engine. Furthermore, there is no need for a shaft which has a plurality of axially spaced bevel gears each of which is arranged to drive a bevel gear of an accessory. This dispenses with the necessity to accurately align the bevel gears on the shaft and the bevel gears of the accessories using shims and thus the assembly of the gearbox assembly is easier and less time consuming.

Although the present disclosure has referred to a gear train in which the spur gear on the shaft of each accessory meshes directly with the spur gear on the shaft of one or more accessories, the gear train of any of the previously described accessory gearbox assemblies may comprise at least one idler gear, the spur gears of a least some of the accessories are arranged to mesh with idler gears to transmit drive through the gear train and the spur gear on the shaft of each accessory may be arranged to mesh with one or more idler gears which mesh with the spur gears on the corresponding shaft of other accessories.

Although the present disclosure has referred to an accessory gearbox being mounted on the core engine casing it is equally possible for an accessory gearbox to be mounted on the fan casing. Although the present disclosure has referred to an accessory gearbox casing mounted on a core engine casing of the gas turbine engine, it may be equally possible for an accessory gearbox casing to be mounted on a fan casing of the gas turbine engine. Although the present disclosure has referred to a core nacelle being arranged around the core engine casing, the accessory gearbox and the plurality of accessories being arranged radially between the core engine casing and the core nacelle it is equally possible for a nacelle to be arranged around the fan casing, the accessory gearbox and the plurality of accessories being arranged radially between the fan casing and the nacelle.

Although the present disclosure has referred to a turbofan gas turbine engine it is equally applicable to a geared turbofan gas turbine engine, especially a geared turbofan gas turbine engine comprising a low pressure turbine arranged to drive an intermediate pressure compressor via a shaft, a fan driven by the low pressure turbine via the shaft and a gearbox and a high pressure turbine arranged to drive a high pressure compressor via a second shaft.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. An accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a shaft,
a first plurality of accessories are secured to a first side of the accessory gearbox casing, the shafts of the first plurality of accessories are parallel, the shaft of each accessory of the first plurality of accessories has a spur gear, the shaft of a first accessory of the first plurality of accessories has a bevel gear,
a second plurality of accessories are secured to a second opposite side of the accessory gearbox casing, the shafts of the second plurality of accessories are parallel, the shaft of each accessory of the second plurality of accessories has a spur gear, the shaft of a second accessory of the second plurality of accessories has a bevel gear,
the gear train comprises the spur gears of the accessories,
the bevel gear of the first accessory is arranged to mesh with a further bevel gear and the bevel gear of the second accessory is arranged to mesh with the further bevel gear, the shafts of the accessories are arranged in a V-shape, and the further bevel gear is arranged to drive the accessory gearbox assembly.

2. An accessory gearbox assembly as claimed in claim 1 wherein the spur gears of a least some of the accessories are arranged to mesh to transmit drive through the gear train.

3. An accessory gearbox assembly as claimed in claim 2 wherein the spur gear on the shaft of each accessory is arranged to mesh with one or more spur gears on the corresponding shaft of other accessories.

4. An accessory gearbox assembly as claimed in claim 1 wherein the gear train comprises at least one idler gear, the spur gears of a least some of the accessories are arranged to mesh with idler gears to transmit drive through the gear train.

5. An accessory gearbox assembly as claimed in claim 4 wherein the spur gear on the shaft of each accessory is arranged to mesh with one or more idler gears which mesh with the spur gears on the corresponding shaft of other accessories.

6. An accessory gearbox assembly as claimed in claim 1 wherein the first accessory is the highest power and/or the highest torque accessory.

7. An accessory gearbox assembly as claimed in claim 6 wherein the first accessory is a starter, an electrical motor or an electrical generator.

8. An accessory gearbox assembly as claimed in claim 1 wherein the first accessory is a starter, an electrical motor or an electrical generator.

9. An accessory gearbox assembly as claimed in claim 1 wherein the second accessory is an electrical generator.

10. An accessory gearbox assembly as claimed in claim 1 wherein the shafts of the first plurality of accessories are arranged in a first plane and the shafts of the second plurality of accessories are arranged in a second plane.

11. An accessory gearbox assembly as claimed in claim 10 wherein the first plane and the second plane are arranged at an angle of less than 180°.

12. An accessory gearbox assembly as claimed in claim 1 wherein the further bevel gear is driven by an additional bevel gear.

13. An accessory gearbox assembly as claimed in claim 12 wherein the further bevel gear is arranged to be driven by a starter or starter motor.

14. A gas turbine engine comprising an accessory gearbox assembly, the accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a shaft,
a first plurality of accessories are secured to a first side of the accessory gearbox casing, the shafts of the first plurality of accessories are parallel, the shaft of each accessory of the first plurality of accessories has a spur gear, the shaft of a first accessory of the first plurality of accessories has a bevel gear,
a second plurality of accessories are secured to a second opposite side of the accessory gearbox casing, the drive shafts of the second plurality of accessories are parallel, the shaft of each accessory of the second plurality of accessories has a spur gear, the shaft of a second accessory of the second plurality of accessories has a bevel gear,
the gear train comprises the spur gears of the accessories,
the bevel gear of the first accessory is arranged to mesh with a further bevel gear and the bevel gear of the second accessory is arranged to mesh with the further bevel gear, the shafts of the accessories are arranged in a V-shape, and the further bevel gear is arranged to drive the accessory gearbox assembly.

15. A gas turbine engine as claimed in claim 14 wherein the shafts of the first plurality of accessories are arranged in a first plane and the shafts of the second plurality of accessories are arranged in a second plane.

16. A gas turbine engine as claimed in claim 15 wherein the first plane and the second plane are arranged at an angle of less than 180°.

17. A gas turbine engine as claimed in claim 14 wherein the further bevel gear is driven by an additional bevel gear.

18. A gas turbine engine as claimed in claim 17 wherein the further bevel gear is arranged to be driven by a starter motor.

19. A gas turbine engine as claimed in claim 14 wherein the further bevel gear is arranged on the radially outer end of a radial drive shaft.

20. A gas turbine engine as claimed in claim 17 wherein the additional bevel gear is arranged on the radially outer end of a radial drive shaft.

21. A gas turbine engine as claimed in claim 14 wherein the accessory gearbox casing is mounted on a core engine casing of the gas turbine engine.

22. A gas turbine engine as claimed in claim 21 wherein a core nacelle is arranged around the core engine casing, the accessory gearbox and the plurality of accessories are arranged radially between the core engine casing and the core nacelle.

23. A gas turbine engine as claimed in claim 22 wherein the gas turbine engine has an axis and the accessory gearbox casing extends axially with respect to the gas turbine engine.

24. A gas turbine engine as claimed in claim 23 wherein the shafts of the first plurality of accessories are arranged in a first plane, the shafts of the second plurality of accessories are arranged in a second plane, the first plane and the second plane are arranged at an angle of less than 180°, the core engine casing is arranged in the angle between the first plane and the second plane.

25. A gas turbine engine as claimed in claim 24 wherein the first and second planes intersect a vertical plane containing the axis of the gas turbine engine.

26. A gas turbine engine as claimed in claim 14 wherein a heat shield is arranged radially between the accessory gearbox and the plurality of accessories and the core casing.

27. A gas turbine engine as claimed in claim 14 wherein the gas turbine engine is a turbofan gas turbine engine.

28. A geared turbofan gas turbine engine comprising an accessory gearbox assembly, the accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a shaft,
a first plurality of accessories are secured to a first side of the accessory gearbox casing, the shafts of the first plurality of accessories are parallel, the shaft of each accessory of the first plurality of accessories has a spur gear, the shaft of a first accessory of the first plurality of accessories has a bevel gear,
a second plurality of accessories are secured to a second opposite side of the accessory gearbox casing, the drive shafts of the second plurality of accessories are parallel, the shaft of each accessory of the second plurality of accessories has a spur gear, the shaft of a second accessory of the second plurality of accessories has a bevel gear,
the gear train comprises the spur gears of the accessories,
the bevel gear of the first accessory is arranged to mesh with a further bevel gear and the bevel gear of the second accessory is arranged to mesh with the further bevel gear, the shafts of the accessories are arranged in a V-shape, and the further bevel gear is arranged to drive the accessory gearbox assembly.

29. A geared turbofan gas turbine engine as claimed in claim 28 wherein the gas turbine engine comprises a low pressure turbine arranged to drive an intermediate pressure compressor via a shaft, a fan driven by the low pressure turbine via the shaft and a gearbox and a high pressure turbine arranged to drive a high pressure compressor via a second shaft.
